(19) United States
(12) Patent Application Publication
(10) Pub. No.: US 2017/0195641 A1
(43) Pub. Date: Jul. 6, 2017

(54) AGRICULTURAL REMOTE SENSING SYSTEM

(71) Applicant: BEIJING RESEARCH CENTER FOR INFORMATION TECHNOLOGY IN AGRICULTURE, Beijing (CN)

(72) Inventors: Guijun YANG, Beijing (CN); Chunjiang ZHAO, Beijing (CN); Bo XU, Beijing (CN); Haiyang YU, Beijing (CN); Haikuan FENG, Beijing (CN); Xiaodong YANG, Beijing (CN)

(21) Appl. No.: 15/318,664

(22) PCT Filed: Aug. 26, 2014
(86) PCT No.: PCT/CN2014/085149

§ 371 Date: Dec. 13, 2016

(30) Foreign Application Priority Data
Jun. 13, 2014 (CN) 201410265864.6

(51) Int. Cl. H04N 7/18; G01S 5/02; B64C 39/02; H04N 5/06; H04N 5/33

(52) U.S. Cl. CPC H04N 7/188; H04N 5/06; H04N 5/332; B64C 39/024; G01S 5/0247; B64C 2201/024; B64C 2201/108

(57) ABSTRACT

Provided is an agricultural remote sensing system. Remote sensors, a POS sensor and a data synchronization device are carried on an unmanned aerial vehicle, so that images conforming to the requirement of spatial resolution can be acquired by controlling the flight altitude of the unmanned aerial vehicle, and geometric splicing is conducted on the images according to position information recorded by the POS sensor, so as to obtain an agricultural remote sensing image in a relatively large area. At the same time, a plurality of remote sensors of different types can be simultaneously carried on a platform of the unmanned aerial vehicle, so that various pieces of image information of different types can be acquired once. On the other hand, in the present invention, after a collection trigger signal is received, the plurality of remote sensors execute the collection of the remote sensing image once, so that the remote sensors can be prevented from always being in an operating state, thereby reducing the power consumption of the unmanned aerial vehicle.

### TECHNICAL FIELD

The present invention relates to the technical field of remote sensing, and particularly relates to an agricultural remote sensing system.

### BACKGROUND

With rapid development of agricultural informatization, there has emerged an urgent need for more abundant information to provide guidance for precise fertilizer and water decisions in fields. In traditional field investigations, restricted by the amount of sampling points and workload, continuous spatial and temporal coverage is difficult to achieve, and using points instead of surfaces, and there is short of spatial and temporal representativeness. In the case of satellite remote sensing observations, although continuous spatial coverage can be achieved, it can hardly be applicable to precise information acquisition of farmland due to its low pixel space resolution, and data cannot be acquired in time due to a long satellite revisit cycle. Manned aerial remote sensing has a problem of a high cost for data acquisition and can hardly be applied widely to agricultural production under the condition of stringent air traffic control in China.

### SUMMARY

An object of the present invention is to provide an agricultural remote sensing system to acquire a high-resolution agricultural remote sensing image in a relatively large area in time.

To achieve the above object, the present invention provides an agricultural remote sensing system, including:

an unmanned aerial vehicle; and a first position and attitude POS sensor, a plurality of remote sensors of different types and a data synchronization module, which are arranged on the unmanned aerial vehicle, where, the first POS sensor, the plurality of remote sensors of different types and the data synchronization module are connected;

the data synchronization module is used for generating a collection trigger signal and inputting the generated collection trigger signal to the POS sensor and the plurality of remote sensors;

the first POS sensor records current position and attitude information after receiving the collection trigger signal, and the plurality of remote sensors execute collection of a remote sensing image once after the collection trigger signal is received; and

the data synchronization module is further used for collecting the position information recorded by the first POS sensor and the remote sensing image collected by the remote sensors, and synchronizing the remote sensing images collected by the remote sensors according to the position information recorded by the first POS sensor.

Preferably, pluralities of remote sensors of different types include an agricultural multispectral sensor, a thermal infrared sensor and a hyperspectral sensor.

Preferably, the first POS sensor, the data synchronization module, the multispectral sensor and the thermal infrared sensor are powered by an unmanned aerial vehicle power supply.

Preferably, an output voltage of the unmanned aerial vehicle power supply is 12V.

Preferably, the unmanned aerial vehicle is a light-weight multi-rotor-wing unmanned aerial vehicle.

Preferably, the unmanned aerial vehicle includes a second POS sensor for measuring a spatial position and attitude of the unmanned aerial vehicle at a moment when the unmanned aerial vehicle collects remote sensing data; and

the data synchronization module is specifically used for generating a collection trigger signal once after every certain flight distance and inputting the generated collection trigger signal to the first POS sensor and the plurality of remote sensors.

Preferably, the second POS sensor is further used for measuring a flight altitude of the unmanned aerial vehicle and determining a distance interval for photography according to the measured flight altitude; and

the data synchronization module is specifically used for generating a collection trigger signal once after every distance interval for photography.

Preferably, the unmanned aerial vehicle includes a carrying platform; the first POS sensor, the plurality of remote sensors of different types and the data synchronization module are detachably arranged on the carrying platform; and the first POS sensor and the plurality of remote sensors of different types are connected to the data synchronization module through a pluggable interface.

Preferably, the data synchronization module further includes a protocol conversion module for protocol conversion of data received by the pluggable interface.

Preferably, the pluggable interface is a USB interface.

In the agricultural remote sensing system provided by the present invention, the remote sensors, the POS sensor and the data synchronization device are carried on the unmanned aerial vehicle, so that images with a resolution meeting the requirement can be acquired by controlling the flight altitude of the unmanned aerial vehicle, and splicing is performed on the images according to position attitude information recorded by the POS sensor, so as to obtain an agricultural remote sensing image in a relatively large area. At the same time, the plurality of remote sensors of different types can be simultaneously carried on the platform of the unmanned aerial vehicle, so that various pieces of image information of different types can be acquired once. On the other hand, in the present invention, after the collection trigger signal is received, the plurality of remote sensors execute the collection of the remote sensing image once, so that the remote sensors can be prevented from always being in an operating state, thereby reducing the power consumption of the unmanned aerial vehicle.

### BRIEF DESCRIPTION OF THE DRAWINGS

FIG. 1 is a schematic structural diagram of an agricultural remote sensing system provided by the present invention.

### DETAILED DESCRIPTION OF THE EMBODIMENTS

Specific implementations of the present invention will be further described below in conjunction with the accompanying drawings and embodiments. The following embodiments are only used for more clearly describing technical solutions of the present invention, rather than limiting the protection scope of the present invention.

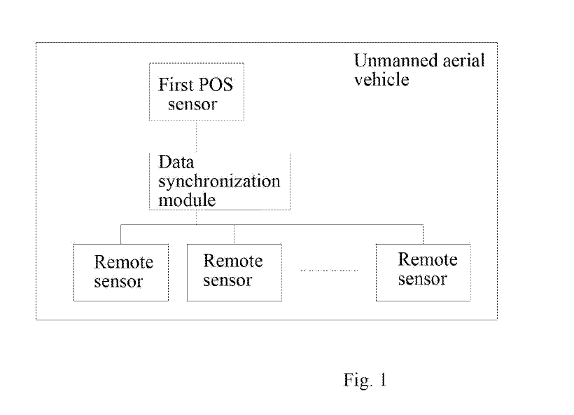

The present invention provides an agricultural remote sensing system, as shown in FIG. 1, including:

an unmanned aerial vehicle; and a position and attitude POS sensor, a plurality of remote sensors of different types and a data synchronization module, which are arranged on the unmanned aerial vehicle, where the first POS sensor, the plurality of remote sensors of different types and the data synchronization module are connected;

the data synchronization module is used for generating a collection trigger signal and inputting the generated collection trigger signal to the POS sensor and the plurality of remote sensors;

the first POS sensor records current position and attitude information after receiving the collection trigger signal, and the plurality of remote sensors execute collection of a remote sensing image once after the collection trigger signal is received; and

the data synchronization module is further used for collecting the position information recorded by the first POS sensor and the remote sensing image collected by the remote sensors, and synchronizing the remote sensing images collected by the remote sensors according to the position information recorded by the first POS sensor.

In the agricultural remote sensing system provided by the present invention, the remote sensors, the first POS sensor and the data synchronization device are carried on the unmanned aerial vehicle, so that images with a resolution meeting the requirement can be acquired by controlling the flight altitude of the unmanned aerial vehicle, and splicing is performed on the images according to position information recorded by the POS sensor, so as to obtain an agricultural remote sensing image in a relatively large area. Moreover, as the unmanned aerial vehicle is easy to operate and control, the collected image can be acquired in time by controlling a flight cycle. In addition, since pluralities of remote sensors of different types are adopted, various pieces of image information of different types can be acquired once.

Preferably, the plurality of remote sensors of different types include a multispectral sensor, a thermal infrared sensor and a hyperspectral sensor.

Preferably, the first POS sensor, the data synchronization module, the multispectral sensor and the thermal infrared sensor are powered by an unmanned aerial vehicle power supply.

In this way, the unmanned aerial vehicle can be avoided from carrying too many power supplies, and the load of the unmanned aerial vehicle is reduced.

Preferably, an output voltage of the unmanned aerial vehicle power supply is 12V.

Preferably, the unmanned aerial vehicle is a light-weight multi-rotor-wing unmanned aerial vehicle.

The flight altitude of the light-weight multi-rotor-wing unmanned aerial vehicle is adjustable, and an operator can acquire images with a resolution meeting the requirement by controlling the flight altitude of the unmanned aerial vehicle; and on the other hand, the light-weight multi-rotor-wing unmanned aerial vehicle can provide a relatively large loading capacity.

Preferably, the unmanned aerial vehicle includes a second POS sensor for measuring a spatial position and attitude of the unmanned aerial vehicle at a moment when the unmanned aerial vehicle collects remote sensing data; and

the data synchronization module is specifically used for generating a collection trigger signal once after every certain flight distance and inputting the generated collection trigger signal to the first POS sensor and the plurality of remote sensors.

In practical applications, if the unmanned aerial vehicle can fly at a preset speed, a frequency of generating the collection trigger signal by the data synchronization module can be set as a fixed value, i.e. enabling the remote sensors to perform collection at a fixed frequency. In this way, through setting a reasonable frequency, the remote sensors can be prevented from collecting images too frequently, thereby reducing the power consumption; and certain overlap of the images photographed by the remote control can be guaranteed, thus enabling complete and precise geometric splicing.

However, in practical applications, wind speed, electric quantity and the like may affect the flight speed of the unmanned aerial vehicle, so the unmanned aerial vehicle may not always fly at the set speed, such that images cannot be spliced correctly. On this basis, in a preferred embodiment of the present invention, the data synchronization module generates a collection signal once after every certain flight distance, thus avoiding the problem that images cannot be spliced correctly due to an abnormal flight speed of the unmanned aerial vehicle.

Preferably, the second POS sensor is further used for measuring a flight altitude of the unmanned aerial vehicle and determining a distance interval for photography according to the measured flight altitude; and

the data synchronization module is specifically used for generating a collection trigger signal once after every distance interval for photography.

In practical applications, if the flight altitude of the unmanned aerial vehicle is relatively high, the field of view of the remote sensors can be enlarged accordingly, and the distance interval between two times of image photography of the remote sensors can be increased accordingly; on the contrary, if the flight altitude is relatively low, the distance interval between two times of image photography needs to be reduced in order to guarantee complete splicing. In a preferred embodiment of the present invention, the unmanned aerial vehicle automatically adjusts the interval for photography according to the flight altitude, and manual adjustment of the interval for photography is avoided.

Preferably, the unmanned aerial vehicle includes a carrying platform; the first POS sensor, the plurality of remote sensors of different types and the data synchronization module are detachably arranged on the carrying platform; and the first POS sensor and the plurality of remote sensors of different types are connected to the data synchronization module through a pluggable interface.

In this way, the remote sensors of the agricultural remote sensing system can be detached very simply, to facilitate maintenance and update of the remote sensors.

Preferably, the data synchronization module further includes a protocol conversion module for protocol conversion of data received by the pluggable interface.

In this way of specifying the data communication protocol format, the data synchronization module can be compatible with remote sensors of different types.

Preferably, the pluggable interface is a USB interface.

Preferred embodiments of the present invention are described below in detail in conjunction with specific embodiments. In an embodiment provided by the present invention,

a data synchronization acquisition device is designed according to working performance indicators and electrical interface features of an agricultural multispectral sensor, a thermal infrared sensor and a hyperspectral imager, has a high integration density, and can be compatible with the above-mentioned various sensors at the same time; specifically, it can be a minitype PC installed with a tailored windows xp system and with an application for synchronously controlling and acquiring the various sensors.

Specific parameters of the data synchronization acquisition device may be as follows:

a. the maximum length, width and height of 112.5 mm, 58 mm and 45.9 mm respectively, and the mass of 315 g; and

b. an external power supply interface of 8-48V for power supply, and three USB2.0 ports to provide various sensor interfaces for controlling the agricultural multispectral sensor, the thermal infrared sensor, the hyperspectral imager, the POS sensor and the like described in Table 1, the data acquired being stored in an external TF card.

With the characteristics of a small size and a low mass of the three types of sensors and the data acquisition device, the multi-rotor-wing unmanned aerial vehicle having a light load and being easy to operate is selected as the carrying platform, with a total weight of 4.3 kg, a maximum load of 3.5 kg, flight time of 20 min, and a flight speed of 2-15 m/s. Depending on a cradle head structural space of the rotor unmanned aerial vehicle, four types of sensors and a multi-sensor data collection device are arranged in a combined manner in the present invention.

Before operation of the system, firstly the sensor components are fixed, then data control and collection signal lines of the remote sensors are connected to USB ports of the multi-sensor data collection device, and finally the power supply is connected and the application in the multi-sensor data collection device is enabled to start synchronously collecting data.

Working performance of the three types of remote sensors adopted in the present invention can be shown in Table 1 (all parameters are calculated in the case of a lens-to-object distance of 50 m);

TABLE 1
Working performance of the three types of remote sensors

| | Pixel | Field of | Maximum | Breadth of | Data | Data |
|---|---|---|---|---|---|---|
| Name of | resolution | view | pixel | single | collection | storage |
| sensor | (cm) | (degree) | (number) | image (m) | frequency | manner |
| Agricultural | 2 | 44.52 * 34.18 | 2048 * 1536 | 65.54 * 49.15 | 0.67 | Picture |
| multispectral | | | | | | |
| sensor | | | | | | |
| Thermal | 8.93 | 38 * 29 | 382 * 288 | 34.11 * 25.72 | 80 | Picture |
| infrared | | | | | | |
| sensor | | | | | | |
| hyperspectral | 12.25 | 31.88 (line | 2048 | 31.88 * 31.88 | 80 | Video |
| imager | | width) | | | | |

Based on the remote sensor parameters shown in Table 1, the flight altitude, speed and route of the unmanned aerial vehicle are adjusted to acquire images with a certain degree of overlapping and a specified resolution. Suppose a situation of use as follows:

A minimum resolution of images of 15cm, a longitudinal overlap degree of 60%, a lateral overlap degree of 30%, and a flight time of 20 min of the unmanned aerial vehicle are provided, and as the resolution of the hyperspectral imager is mininum, calculation is performed here with its maximum resolution of 15 cm, and specific parameters are shown in Table 2:

TABLE 2
Image parameters of the remote sensors and a flight scheme of the unmanned aerial vehicle

| | | | | | | | Coverage |
|---|---|---|---|---|---|---|---|
| | | | | | Longitudinally | | of |
| | Pixel | Flight | Flight | Size of | acquired | Lateral | single |
| Name of | resolution | altitude | speed | single | data interval | spacing | flight |
| sensor | (cm) | (m) | (m/s) | image (m) | (s) | (m) | (mu) |
| Agricultural | 2.44 | 61 | 12 | 79.96 * 59.96 | 1 | 27.22 | 943.2 |
| multispectral | | | | | | | |
| sensor | | | | | | | |
| Thermal | 10.9 | 61 | 12 | 41.61 * 31.38 | 1 | 27.22 | 943.2 |
| infrared | | | | | | | |
| sensor | | | | | | | |
| hyperspectral | 15 | 61 | 12 | 38.89 * 38.89 | Continuous | 27.22 | 943.2 |
| imager | | | | | collection | | |

Based on the various parameters listed in the above table, calculation is performed with a longitudinal overlap degree of 60% and a lateral overlap degree of 30%, and the agricultural multispectral sensor requires that the unmanned aerial vehicle collects image data once after every 23.98m (59.96*(1-60%)), which parameter is 12.55 m for the thermal infrared sensor; the hyperspectral imager acquires data in a linear push-broom manner with a push-broom distance of 12 m per second (a product of a resolution of 15 cm and a push-broom frequency of 80 Hz), which just conforms to the flight speed of the unmanned aerial vehicle and meets the requirement of full coverage of images; thus the unmanned aerial vehicle is designed to have a flight altitude of 61 m and a flight speed of 12 m/s; and in order to synchronously acquire data of the three types of sensors, the multi-sensor data collection application is designed to collect image data of the agricultural spectral sensor and image data of the thermal infrared sensor at a frequency of 1.0 Hz, and the hyperspectral imager continuously collects data at a maximum frequency of 80 Hz. In the three types of sensors, the hyperspectral imager has a smallest transverse breadth of a single image (38.88 m), and a precondition for guaranteeing the three types of sensors have a minimum lateral overlap degree of 30% is to design the unmanned aerial vehicle to have a flight strip spacing with a maximum value of 27.22. While the three remote sensors collect data, the data collection control application collects, at a frequency of 100 Hz, the spatial positions at the photography moments of the sensors and attitude information of the sensors, which are also automatically recorded in a data collection storage card.

After the sensors are connected, the power supply is connected, a data collection program is enabled, and the flight altitude of 61 m, the flight speed of 12 m/s, and the flight strip spacing of 27.22 m are set; after such preparation work is completed, the multi-rotor-wing unmanned aerial vehicle can automatically take off, flies along an automatically planned route, and automatically returns to the take-off place and lands after the flight is completed.

Described above are preferred embodiments of the present invention, and it should be noted that to those of ordinary skill in the art, a number of improvements and modifications may also be made without departing from technical principles of the present invention, and these improvements and modifications should also fall within the protection scope of the present invention.

1. An agricultural remote sensing system, characterized by comprising an unmanned aerial vehicle; and a first position and attitude POS sensor, a plurality of remote sensors of different types and a data synchronization module, which are arranged on the unmanned aerial vehicle, wherein the first POS sensor, the plurality of remote sensors of different types and the data synchronization module are connected;
the data synchronization module is used for generating a collection trigger signal and inputting the generated collection trigger signal to the POS sensor and the plurality of remote sensors;
the first POS sensor records current position and attitude information after receiving the collection trigger signal, and the plurality of remote sensors execute collection of a remote sensing image once after the collection trigger signal is received; and
the data synchronization module is further used for collecting the position information recorded by the first POS sensor and the remote sensing image collected by the remote sensors, and synchronizing the remote sensing images collected by the remote sensors according to the position information recorded by the first POS sensor.

2. The system of claim 1, wherein the plurality of remote sensors of different types include an agricultural multlspectral sensor, a thermal infrared sensor and a hyperspectral sensor.

3. The system of claim 2, wherein the first POS sensor, the data synchronization module, the multlspectral sensor and the thermal infrared sensor are powered by an unmanned aerial vehicle power supply.

4. The system of claim 3, wherein an output voltage of the unmanned aerial vehicle power supply is 12V.

5. The system of claim 1, wherein the unmanned aerial vehicle is a light-weight muiti-rotor-wing unmanned aerial vehicle.

8. The system of claim 1, wherein the unmanned aerial comprises a second POS sensor for measuring a spatial position and attitude of the unmanned aerial vehicle at a moment when the unmanned aerial vehicle collects remote sensing data; and
the data synchronization module is specifically used for generating a collection trigger signal once after every certain flight distance and inputting the generated collection trigger signal to the first POS sensor and the plurality of remote sensors.

7. The system of claim 6, wherein the second POS sensor is further used for measuring a flight altitude of the unmanned aerial vehicle and determining a distance Interval for photography according to the measured flight altitude; and
the data synchronization module is specifically used for generating a collection trigger signal once after every distance interval for photography.

8. The system of claim 1, wherein the unmanned aerial vehicle comprises a carrying platform; the first POS sensor, the plurality of remote sensors of different types and the data synchronization module are detachabiy arranged on the carrying platform; and the first POS sensor and the plurality of remote sensors of different types are connected to the data synchronization module through a pluggable interface.

9. The system of claim 1, wherein the data synchronization module further comprises a protocol conversion module for protocol conversion of data received by the pluggable interface.

10. The system of claim 9, wherein the pluggable interface is a USB interface.
